(19) United States
(12) Patent Application Publication
(10) Pub. No.: US 2015/0244455 A1
(43) Pub. Date: Aug. 27, 2015

(54) CALCULATING TIME OFFSET

(71) Applicant: Hangzhou H3C Technologies Co., Ltd., Hangzhou, Zhejiang (CN)

(72) Inventor: Xuewei Liang, Haidian District (CN)

(21) Appl. No.: 14/373,869

(22) PCT Filed: Mar. 8, 2013
(86) PCT No.: PCT/CN2013/072354

§ 371 Date: Jul. 22, 2014

(30) Foreign Application Priority Data
Mar. 27, 2012 (CN) 201211084146.X

(51) Int. Cl. H04B 10/077; H04B 10/25

(52) U.S. Cl. CPC H04B 10/0775; H04B 10/25

(57) ABSTRACT

A slave device sends a first test signal via a downlink optical waveguide to a master device and recording a first transmission time, receives the first test signal looped back by the master device via the downlink optical waveguide and records a first reception time, and calculates a downlink delay time based on the first transmission and the first reception times. The slave device sends a second test signal via an uplink optical waveguide to the master device and records a second transmission time, receives the second test signal looped back by the master device via the uplink optical waveguide and records a second reception time, and calculates the uplink delay time based on the second transmission and the second reception times. Then, the slave device calculates a time offset between the master device and the slave device based on the downlink and the uplink delay times.

### BACKGROUND

In a computer network having a plurality of network segments, a clock distribution system is required for synchronising one or more clocks in the communication system of each segment. The architecture of a clock distribution system may for example be based on NTP (Network Time Protocol) or PTP (Precision Time Protocol) including IEEE1588 V1, IEEE1588 V2 and IEEE802.1AS (incorporated herein by reference). The one or more clocks may for example be an ordinary clock, a boundary clock or a transparent clock. For a communication system with a plurality of clocks, the plurality of clocks may include a source of synchronisation reference—a master device—and a destination for the synchronisation reference—a slave device, and the master and slave devices are generally connected via an uplink connection for transmissions from the slave device to the master device, and a downlink connection for transmission from the master device to the slave device, where the uplink and downlink connections may be optical waveguides such as optical fibres.

### BRIEF DESCRIPTION OF FIGURES

FIG. 1 is a schematic representation of a communication system;

FIG. 2 is a flow diagram of an example of a clock synchronisation method;

FIG. 3 is a schematic diagram of an example of a communication system; and

FIG. 4 is a modification of the communication system of FIG. 3.

### DETAILED DESCRIPTION

According to an example, a slave device calculates a time offset based on a downlink delay time and an uplink delay time between a master device and the slave device so as to synchronised with reference to the master device. Since both a downlink delay time and an uplink delay time are separately obtained, instead of assuming that the two delay times are the same, the contribution to the time offset from the delays in the downlink path and the uplink path between the slave device and the master device may be more accurately obtained.

In the example, the slave device obtains the downlink delay time based on a first transmission time and a first reception time by sending a first test signal via a downlink optical waveguide to the master device and recording the first transmission time, and receiving the first test signal looped back by the master device via the downlink optical waveguide and recording the first reception time. The slave device obtains the uplink delay time based on a second transmission time and a second reception time by sending a second test signal via an uplink optical waveguide to the master device and recording the second transmission time, and receiving the second test signal looped back by the master device via the uplink optical waveguide and recording the second reception time. Since the test signals are looped back by the master device, it is possible to minimise any processing time at the master device, and obtain only the time delay caused by the transit over the uplink and downlink connections. Moreover, as both the transmission time and the reception time of a test signal may be collected at the slave device, which is the side to be synchronised, the efficiency of time measurement is improved.

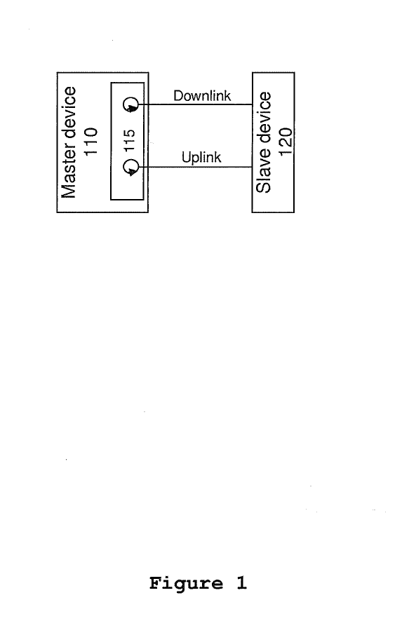

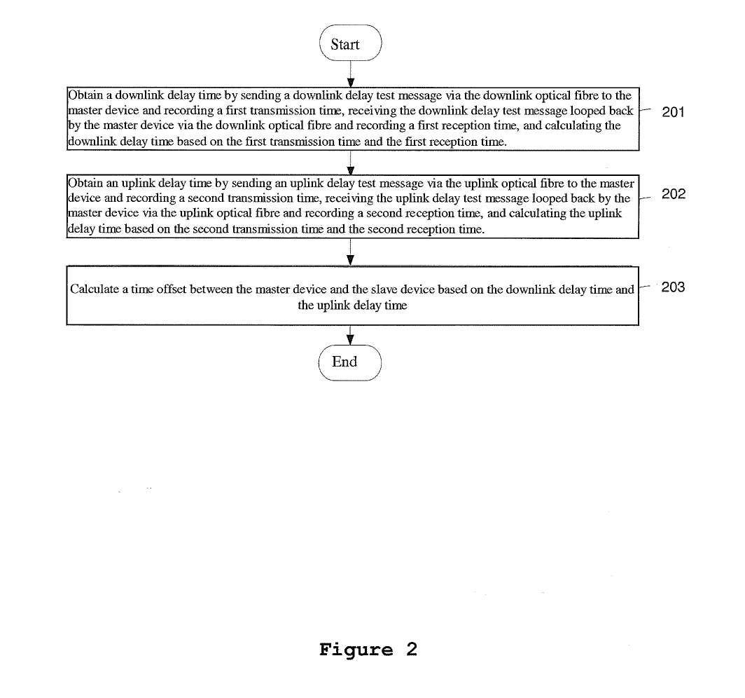

An example of a communication system is schematically shown in FIG. 1, which comprises a master device 110 and a slave device 120. FIG. 2 is a flow diagram depicting an example of a method for determining a time delay between a master device and a slave device, for example the master device 110 and the slave device 120, in order to perform clock synchronization for a communication system. In the communication system, the slave device 120 is connected to the master device 110 via a downlink connection and an uplink connection such as optical fibres.

At block 201, the slave device 120 obtains a downlink delay time that is a transit time for transmission to travel between the slave device 120 and the master device 110 via the downlink connection.

In the example, the slave device 120 sends a downlink delay test message (first test signal) via the downlink optical fibre to the master device 110, and records the time at which the downlink delay test message was transmitted as a first transmission time T1_{down}. Upon receiving the downlink delay test message, the master device 110 loops the downlink delay test message back to the slave device 120 via the downlink optical fibre. For example, the master device 110 may perform the loopback using a loopback module 115 such as a commercially available loopback device, a 1:2 optical beam splitter, or any other devices suitable for loopback. The slave device 120 records the time at which the looped back downlink delay test message is received as a first reception time T2_{down}. Using the first transmission time and the first reception time, the slave device 120 calculates the downlink delay time.

At block 202, the slave device 120 obtains an uplink delay time that is a transit time for transmission to travel between the slave device 120 and the master device 110 via the uplink connection.

In the example, the slave device 120 sends an uplink delay test message (second test signal) via the uplink optical fibre to the master device 110, and records the time at which the uplink delay test message was transmitted as a second transmission time T1ᵤₚ. Upon receiving the uplink delay test message, the master device 110 loops the uplink delay test message back to the slave device 120 via the uplink optical fibre using a suitable loopback module 115. The slave device 120 records the time at which the looped back uplink delay test message is received as a second reception time T2ᵤₚ. Using the second transmission time and the second reception time, the slave device 120 calculates the uplink delay time.

At block 203, the slave device 120 calculates a time offset between the master device 110 and the slave device 120 based on the obtained downlink delay time and uplink delay time.

In the example, separately obtained downlink delay time and uplink delay time are used for determining the time offset between the master device and the slave device. In this case, it is possible to separately determine the transit time which a downlink signal would take to travel from the master device to the slave device via the downlink connection, and the transit time which an uplink signal would take to travel from the slave device to the master device via the uplink connection. Compared to the case in which both downlink and uplink are assumed to have the same delay, the present example is able to obtain a more accurate time offset.

In an example, the downlink delay time may be obtained by calculating a downlink path delay PathDelay_{down}=(T2_{down}−T1_{down})/2 using the first transmission time T1_{down} and the first reception time T2_{down}. Since the time difference (T2_{down}−T1_{down}) is a round-trip time, it is divided by 2 to obtain the path delay for a single trip. In another example, the downlink delay may be obtained by repeating the measurement of T1_{down} and T2_{down} a plurality of times to calculate the respective PathDelay_{down}, and averaging the plurality of PathDelay_{down}. In the case where multiple values of PathDelay_{down} are obtained, it may be desirable to eliminate any values of PathDelay_{down} that appears abnormal, for example unusually large or small values, before averaging the plurality of PathDelay_{down}, in order to obtain a more accurate and reliable downlink delay time.

In an example, the uplink delay time may be obtained by calculating an uplink path delay PathDelayᵤₚ=(T2ᵤₚ−T1ᵤₚ)/2 using the second transmission time T1ᵤₚ and the second reception time T2ᵤₚ. Again, since the time difference (T2ᵤₚ−T1ᵤₚ) is a round-trip time, it is divided by 2 to obtain the path delay for a single trip. In another example, the uplink delay may be obtained by repeating the measurement of T1ᵤₚ and T2ᵤₚ a plurality of times and calculating the respective PathDelayᵤₚ, and averaging the plurality of PathDelayᵤₚ. In the case where multiple values of PathDelayᵤₚ are obtained, it may be desirable to eliminate any values of PathDelayᵤₚ that appears abnormal before averaging the plurality of PathDelayᵤₚ, in order to obtain a more accurate and reliable uplink delay time.

In an example, the clock synchronisation between the master device and the slave device may be performed according to a IEEE1588 protocol or any other suitable clock synchronisation protocols. In particular, the offset between the master device and the slave device may be calculated using the expression,

$$Offset = \frac{( {PathDelay}_{down} - {PathDelay}_{up} )}{2} + \frac{2 Δ sm}{2}$$

where Δsm is an absolute delay between the slave device and the master device.

The absolute delay Δsm represents systematic delays between the time at which the master device sends a signal until the time at which the slave device receives the signal, which may include processes that take place within the master device from the time the signal is generated to the time the signal is timestamped by the master device, and from the time the signal is timestamped to the time at which the signal arrives at the physical interface of the master device.

On the other hand, the downlink path delay PathDelay_{down} and the uplink path delay PathDelayᵤₚ determined according to the example use test signals directly looped back by the master device without processing. Thus, the downlink path delay PathDelay_{down} and the uplink path delay PathDelayᵤₚ represent delays caused only by network connections that respectively form the downlink connection and the uplink connection. By determining the offset in time between the master device and itself, the slave device may then adjust its clock accordingly to be in synchronisation with the master device. In the example, PathDelay_{down} and PathDelayᵤₚ may be determined as described above as a single value or an average of multiple values. The quantity (PathDelay_{down}|PathDelayᵤₚ)/2 represents the asymmetry between the delay in the downlink connection and the delay in the uplink connection. Thus, in an example, the slave device may calculate a time offset between the master device and the slave device using the delay asymmetry DelayAsymmetry=(PathDelay_{down}−PathDelayᵤₚ)/2.

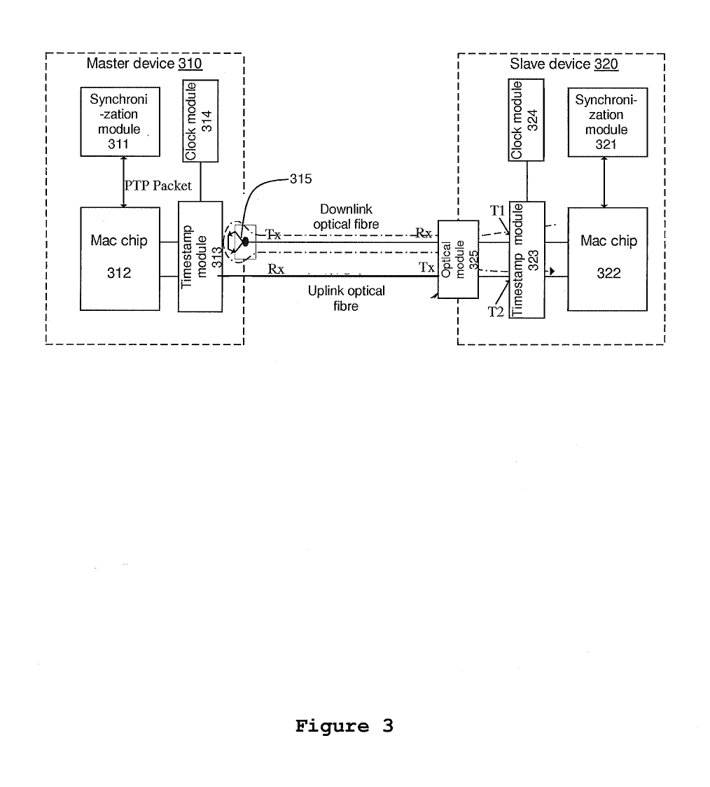

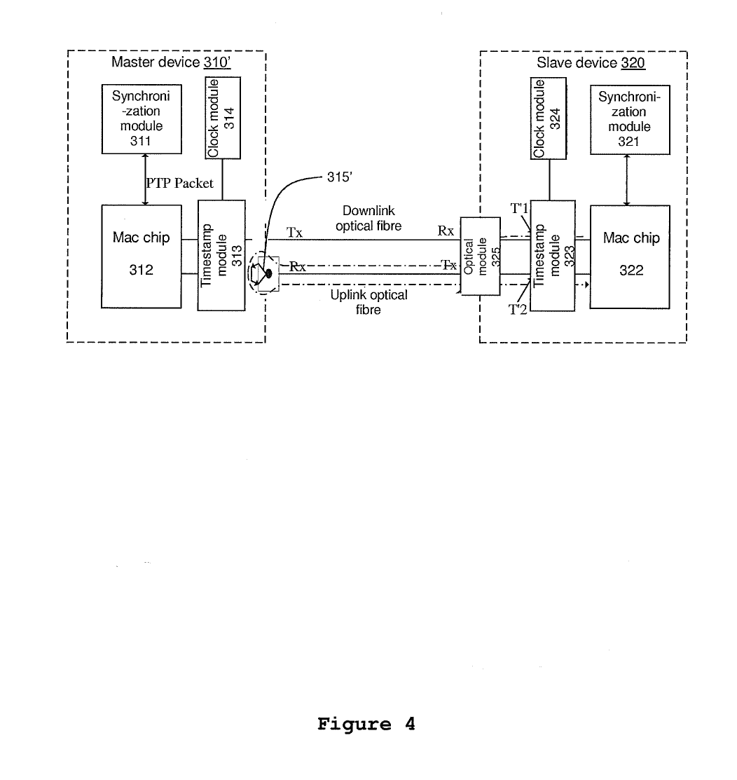

An example of a communication system that performs clock synchronisation using the method described above is shown in FIG. 3 and FIG. 4. The communication system comprises a master device 310 or 310′ and a slave device 320. The slave device 320 is connected to the master device 310 or 310′ via a downlink connection and an uplink connection. The connections may be optical waveguides such as optical fibres. Each of the downlink and uplink connections may include multiple connections, for example, via a switch or a router.

In FIG. 3, the master device 310 comprises a synchronization module 311, a network interface controller such as a MAC chip 312, a timestamp module 313, a clock module 314 and a loopback module 315. The loopback module 315 may be a loopback device, an optical beam splitter, or any other devices suitable for looping back an optical signal. The slave device 320 comprises a synchronization module 321, a network interface controller such as a MAC chip 322, a timestamp module 323, a clock module 324 and an optical module 325. The synchronisation modules 311 and 321 communicate respectively with the timestamp modules 313 and 323 via the respective MAC chip 312 and 322. The slave device 320 is connected to the master device 310 by a downlink optical fibre and an uplink optical fibre. One end of the downlink optical fibre is connected to the slave device 320 via the optical module 325. The other end of the downlink optical fibre is connected to the master device 310 via the loopback module 315.

In the example, referring to FIG. 3, the synchronization module 311 of the slave device 320 generates a downlink delay test message (first test signal) and forwards the downlink delay test message to the optical module 325 via the MAC chip 322. The optical module 325 sends the downlink delay test message down the downlink optical fibre, and the timestamp module 323 records the time at which the downlink delay test message is sent as a first transmission time T1_{down}.

The loopback module 315 of the master device 310 receives the downlink delay test message via the downlink optical fibre and loops the downlink delay test message back down the downlink optical fibre.

The optical module 325 receives the downlink delay test message looped back by the master device 310 via the downlink optical fibre, and the timestamp module 323 records the time at which the downlink delay test message is received as a first reception time T2_{down}. The timestamp module 323 then calculates a downlink delay time based on the first transmission time T1_{down} and the first reception time T2_{down}.

In an example, the timestamp module may be configured to calculate the downlink delay time by calculating a downlink path delay PathDelay_{down}=(T2_{down}−T1_{down})/2 using the first transmission time T1_{down} and the first reception time T2_{down}.

Referring now to FIG. 4, the slave device 320 in FIG. 4 is essentially the same as the slave device 320 in FIG. 3. The master device 310′ is an alternative configuration of the master device 310, and differs from the master device 310 in that the loopback module 315′ is connected to the uplink optical fibre instead of the downlink optical fibre. In the present example, the loopback module 315 may simply be moved from the downlink optical fibre to the uplink optical fibre, thus preserving measurement consistency. However, a loopback module 315′ different from the loopback module 315 may be used depending on design requirements. In an alternative example, the master device 310 (or 310′) may be provided with two loopback modules each respectively connected to the downlink optical fibre and the uplink optical fibre.

The synchronization module 311 of the slave device 320 then generates an uplink delay test message (second test signal) and forwards the uplink delay test message to the optical module 325 via the MAC chip 322. The optical module 325 sends the uplink delay test message down the uplink optical fibre, and the timestamp module 323 records the time at which the uplink delay test message is sent as a second transmission time T1ᵤₚ.

The loopback module 315′ of the master device 310 receives the uplink delay test message via the uplink optical fibre and loops the uplink delay test message back down the uplink optical fibre.

The optical module 325 receives the uplink delay test message looped back by the master device 310 via the uplink optical fibre, and the timestamp module 323 records the time at which the uplink delay test message is received as a second reception time T2ᵤₚ. The timestamp module 323 then calculates an uplink delay time based on the second transmission time T1ᵤₚ and the second reception time T2ᵤₚ.

The timestamp module 323 calculates a time offset between the master device and the slave device based on the downlink delay time and the uplink delay time.

In an example, the timestamp module 323 may be configured to calculate the uplink delay time by calculating an uplink path delay PathDelayᵤₚ=(T2ᵤₚ−T1ᵤₚ)/2 using the second transmission time T1ᵤₚ and the second reception time T2ᵤₚ.

In an example, the optical module 325 may be any suitable optical module including a single strand bidirectional optical transceiver, the loopback module 315 and 315′ may be any suitable loopback device including a beam splitter.

According to the examples above, since both a downlink delay time and an uplink delay time are separately obtained, the time offset between the slave device and the master device may be more accurately determined.

According to the examples above, since the test signals are looped back by the master device, no processing is required at the master device side and the master device is not required to generate and transmit a separate test signal, thus it is possible to separate network transit delays from systematic delays. Moreover, both the transmission time and the reception time of a test signal may be collected at the slave device that is the side to be synchronised, thus it is possible to improve efficiency.

In the examples above, the clock synchronisation method is applied to IEEE1588 protocol. However, the clock synchronisation method may be applied to various versions of IEEE1588 and other time synchronisation protocols such as NTP.

Although the flow diagrams described above show a specific order of execution, the order of execution may differ from that which is depicted.

The above examples can be implemented by hardware, software, firmware, or a combination thereof. For example, the various methods and functional modules described herein may be implemented by a processor (the term processor is to be interpreted broadly to include a CPU, processing unit, ASIC, logic unit, or programmable gate array etc.). The methods and functional modules may all be performed by a single processor or divided amongst several processors. The methods and functional modules may be implemented as machine readable instructions executable by one or more processors, hardware logic circuitry of the one or more processors, or a combination thereof. Further, the teachings herein may be implemented in the form of a software product, the computer software product being stored in a storage medium and comprising a plurality of instructions for making a computer device (e.g. a personal computer, a server or a network device such as a router, switch, access point etc.) implement the method recited in the examples of the present disclosure.

It should be understood that embodiments of the clock synchronisation method for a communication system described above are implementation examples only, and do not limit the scope of the invention. Numerous other changes, substitutions, variations, alternations and modifications may be ascertained by those skilled in the art, and it is intended that the present disclosure encompass all such changes, substitutions, variations, alterations and modifications as falling within the spirit and scope of the appended claims.

1. A method comprising:
a slave device obtaining a downlink delay time by:
sending a first test signal via a downlink optical waveguide to a master device and recording a first transmission time of the first test signal;
receiving the first test signal looped back by the master device via the downlink optical waveguide and recording a first reception time of the first test signal;
calculating the downlink delay time based on the first transmission time and the first reception time;
the slave device obtaining an uplink delay time by:
sending a second test signal via an uplink optical waveguide to the master device and recording a second transmission time of the second test signal;
receiving the second test signal looped back by the master device via the uplink optical waveguide and recording a second reception time of the second test signal;
calculating the uplink delay time based on the second transmission time and the second reception time; and
the slave device calculating a time offset between the master device and the slave device based on the downlink delay time and the uplink delay time.

2. The method according to claim 1, wherein the downlink delay time is obtained by calculating a downlink path delay PathDelay_{down}=(T2_{down}−T1_{down})/2 using the first transmission time T1_{down} and the first reception time T2_{down}.

3. The method according to claim 2, wherein the downlink delay is obtained by calculating a plurality of PathDelay_{down} and averaging the plurality of PathDelay_{down}.

4. The method according to claim 1, wherein the uplink delay time is obtained by calculating an uplink path delay PathDelayᵤₚ=(T2ᵤₚ−T1ᵤₚ)/2 using the second transmission time T1ᵤₚ and the second reception time T2ᵤₚ.

5. The method according to claim 4, wherein the downlink delay is obtained by calculating a plurality of PathDelayᵤₚ and averaging the plurality of PathDelayᵤₚ.

6. The method according to claim 1, wherein the calculating a time offset between the master device and the slave device comprises calculating a delay asymmetry DelayAsymmetry=(PathDelay_{down}−PathDelayᵤₚ)/2 based on the downlink delay time PathDelay_{down} and the uplink delay time PathDelayᵤₚ.

7. The method according to claim 1 wherein the clock synchronisation between the master device and the slave device is based on a IEEE1588 protocol.

8. A slave device for use in a communication system comprising a master device and the slave device, the slave device comprising:
an optical module to send to the master device a first test signal via a downlink optical waveguide and a second test signal via an uplink optical waveguide, and to receive the first test signal looped back by the master device via the downlink optical waveguide and the second test signal looped back by the master device via the uplink optical waveguide; and
a timestamp module to record a first transmission time at which the optical module sends the first test signal and a second transmission time at which the optical module sends the second test signal, to record a first reception time at which the optical module receives the first test signal and a second reception time at which the optical module receives the second test signal, to calculate a downlink delay time based on the first transmission time and the first reception time and an uplink delay time based on the second transmission time and the second reception time, and to calculate a time offset between the master device and the slave device based on the downlink delay time and the uplink delay time.

9. The device according to claim 8 further comprises a synchronization module to generate the first test signal and the second test signal, and to forward the first test signal and the second test signal to the optical module for sending to the master device.

10. The device according to claim 8 wherein the timestamp module is to calculate the downlink delay time by calculating a downlink path delay PathDelay_{down}=(T2_{down}−T1_{down})/2 using the first transmission time T1_{down} and the first reception time T2_{down}.

11. The device according to claim 8, wherein the timestamp module is to calculate the uplink delay time by calculating an uplink path delay PathDelayᵤₚ=(T2ᵤₚ−T1ᵤₚ)/2 using the second transmission time T1ᵤₚ and the second reception time T2ᵤₚ.

12. The device as set forth in any of claim 8, wherein the optical module is a single strand bidirectional optical transceiver.

13. A communication system comprising a master device and a slave device according to claim 8 connected to the master device via a downlink optical waveguide and an uplink optical waveguide, the master device comprising a loopback module to receive the first test signal from the slave device via the downlink optical waveguide and to loopback the first test signal to the slave device via the downlink optical waveguide, and to receive the second test signal from the slave device via the uplink optical waveguide and to loopback the second test signal to the slave device via the uplink optical waveguide.
